(19) United States
(12) Patent Application Publication
(10) Pub. No.: US 2026/0222329 A1
(43) Pub. Date: Jul. 30, 2026

(54) TEST CONFIGURATION DERIVATION SYSTEM

(71) Applicant: Tusas- Turk Havacilik Ve Uzay Sanayii Anonim Sirketi, Kahramankazan, Ankara (TR)

(72) Inventors: Muhammed Efe ALTUNTAS, Kahramankazan, Ankara (TR); Ibrahim HOKELEK, Kavaklidere, Ankara (TR); Muhammet Selim DEMIR, Ankara (TR)

(73) Assignee: Tusas- Turk Havacilik Ve Uzay Sanayii Anonim Sirketi, Kahramankazan, Ankara (TR)

(21) Appl. No.: 19/143,017

(22) PCT Filed: Nov. 15, 2023
(86) PCT No.: PCT/TR2023/051335

§ 371 Date: Jun. 25, 2025

(30) Foreign Application Priority Data
Dec. 28, 2022 (TR) 2022/021081

(51) Int. Cl. H04L 43/50; H04L 41/0803

(52) U.S. Cl. CPC H04L 43/50; H04L 41/0803

(57) ABSTRACT

The present invention relates to multiple electronic equipment (2) that can communicate with each other; at least one computer network (3) forming Ethernet data network for the electronic equipment (2); at least one switch (4) that manages data communication in the computer network (3); at least one port (5) that provides data input and/or output between the electronic equipment (2); at least one processor (6) that enables performance testing of the computer network (3);
predetermining multiple parameters of the port (5) for testing the computer network (3) by the user (601);
predetermining, by the user, a level of each parameter that indicates the possible values for the parameters, and the data at these levels (602); creating at least one factor with the parameters pre-selected by the user among multiple parameters (603);
creating at least one variable with the parameters pre-selected by the user, other than the parameters in the factor (604);
obtaining combinations of data at the levels of at least two factors, and creating configurations by performing a matching process in the combinations (605)

This invention relates to creation of configurations for testing computer networks.

Extensive testing of all possible configurations for a system under test (SUT) is unrealistic under time and processing power resource constraints. Testing for complex systems is a long-term and laborious task. This is especially true when the system under test has a large number of test configurations and a series of tests must be executed for each configuration. For example, Ethernet-based deterministic networking (DTN) technologies have been developed to cope with the high-speed data communication requirements of modern avionics applications. Deterministic networks operate using a global sense of time and a shared schedule among network components. ARING 664, a widely used DTN technology, provides limited latency and jitter when safety-critical applications communicate with each other over avionic networks within an aircraft. Testing ARING 664 switches is a challenging task due to their security-critical nature, availability of numerous configuration options, and high-speed operation using thousands of virtual links. The most important elements of an ARING 664 DTN are the switch, end systems and virtual links. Applications running on different end systems communicate with each other using virtual links directed by the switch. Limited latency and jitter requirements for Virtual Links are met by ARING 664's offline scheduling. The number of virtual links, source and destination end systems, minimum and maximum frame sizes, and bandwidth allocation gap (BAG) for all virtual links are parameters in the computer network. The main idea behind providing deterministic communication is to adjust allowed frame size and BAG values to achieve the desired delay and jitter targets, so that an amount of traffic injected into a network by each virtual link is limited. BAG specifies the minimum transmission time between the first bits of two consecutive frames. A traffic shaping mechanism running on each virtual link will control the amount of traffic added by each node and shape traffic that exceeds the average and peak rates. The switch will enforce filtering and monitoring requirements, limit error propagation, and ensure determinism.

Orthogonal Arrays (OAs) are among the mathematical tools for designing an optimal mixture of multiple variables in a series of experiments. They are effective in reducing the number of experiments where a large number of combinations will be required. They are classified as same level and mixed level orthogonal arrays. In general, an orthogonal array is defined as a tuple of 4 variables: OA(N, F, L, S). N is the number of experiments (also called runs), representing the number of rows in an orthogonal array; while the factor F is the number of columns in an orthogonal array where each column corresponds to a variable of the experiment. L is the number of levels representing the number of different possible values for a factor. S is called the power of an OA (0<S≤F). An orthogonal array is designed to obtain the number of rows L^{S} required to contain S-wise combinations of variables. When S=F, all possible combinations of variables are included in the experiment. By setting smaller values for S, a user can choose the degree of combinations of variables to be considered. If all F factors have the same number of L levels, the orthogonal arrays are called same-level orthogonal arrays. Orthogonal arrays allow reducing the number of runs to L^{S} by choosing a value of S to include S-method variable combinations. For example, when S is set to 2, all combinations of binary variables can be covered. Due to time constraints where λ is a real number between 0 and 1, the number of runs can be further reduced to N=λ·L^{S}. The choice of λ is determined by testers depending on the complexity and number of parameters of the particular system under test, so that smaller values are preferred for complex systems. However, in real-life situations, some factors may have different numbers of levels to test. For example, on an ARINC 664 switch, mapping of incoming traffic flows to outgoing ports may have a large number of possible assignments to test (for example, up to 24 ports), while the number of different priorities for a flow may require many fewer options (for example, two priorities, high and low). Orthogonal arrays with factors at different levels are called mixed-level orthogonal arrays. The variable groups of a mixed-level orthogonal array are defined as: OA (N, L₁^{|F}^{₁}^{|}L₂^{|F}^{₂}^{|}. . . Lᵥ^{|F}^{ᵥ}^{|}, S). |Fᵢ| is the number of different factors with the same number of Lᵢ levels for i=(1, 2 , . . . v) and

$${\sum }_{i = 1}^{v} \vert {F}_{i} \vert = F .$$

U.S. Pat No. 5,831,995, which is included in the known-state of the art, discloses a method developed to create more possibilities of test operations using an orthogonal array with the optimum number of tests. Said method aims to create the most effective test combination group within the scope of parameters and levels among the orthogonal arrays created for commands with a predetermined number of parameters and a predetermined number of levels within these parameters, and to create inter-operation orthogonal arrays by using intra-operation orthogonal arrays. Five different tests are created by combining the commands in different operations on the same line, and a final orthogonal series are created by combining the commands obtained in different scenarios.

U.S. Pat. No. 9,746,850, which is included in the known-state of the art, discloses running different and multiple level and test factor scenarios more effectively in orthogonal arrays used in consistency tests for products. The test factors are divided to form multiple groups, and a separate orthogonal series is run with the multiple level sets created, and then the divided groups are combined. After running multiple divided orthogonal arrays, each row in the orthogonal array is matched with other related level sets to create different combinations of level sets, and different combinations are created by running the test again, so that numerous different scenarios are effectively tested.

Thanks to a test configuration derivation system according to the present invention, new parameter created with a first orthogonal array is used in a second orthogonal array, enabling optimum selection of multiple variables in the experimental sets and derivation of the optimum number of configurations.

Another object of the invention is to use important parameters more frequently in the final configurations by grouping the parameters to be tested according to their importance levels, to minimize the effect of dominant parameters in the final configurations, and to reduce the processing capacity by obtaining optimum configurations.

The test configuration derivation system realized to achieve the object of the invention, which is defined in the first claim and other claims dependent thereon, comprises multiple electronic equipment communicating with each other. There is at least one computer network that realizes the Ethernet data network between the electronic equipment. At least one switch is provided, which manages data communication between electronic equipment in the computer network. At least one port on the electronic equipment provides the input and/or output of data between electronic equipment. A processor enables performance testing of the computer network. Multiple parameters are detected by the user to test the computer network. Among the detected parameters, multiple factors passing through each port are determined by the user. There are multiple variables selected from the parameters determined by the factors determined by the user to affect the operating performance. There is no parameter at the intersection of the variable and the factor. The levels of each parameter, and therefore each factor and variable, determined for the port, and data at each level are provided. Configurations that can be tested are produced by combining and/or matching combinations of data at the factor levels. The processor enables execution of the method comprising the steps of: selecting parameters, selecting the levels of the parameters and the data at the levels, separating the parameters into two groups as factors and variables, and combining and/or matching combinations of at least two factors, so that the configurations are created.

The test configuration derivation system according to the invention comprises an feature obtained by using configurations created by combining and/or matching combinations of data at the levels of factors. An feature with a level value is created, as many as the number of configurations obtained by combining and/or matching combinations created using data at the factor levels. The data for each level of the feature is created by combining the data of the configuration that creates that level. Configurations are obtained by combining and/or matching combinations of the data of the variables and the combined data of the feature. In these configurations, the same data of the feature is used with different variable combinations. The processor enables optimum number of configurations to be obtained by the method of creating the feature, and combining and/or matching the combinations obtained from the feature and variable data.

In an embodiment of the invention, the test configuration derivation system comprises the processor that allows applying an orthogonal array to the factors. In this way, configurations with factor data are obtained. Features with as many levels as the number of configurations obtained, are created by the processor. The levels of the feature are created by combining the data of the configuration that forms each level. Said combining process is writing the data side by side, thus obtaining a single data. Configurations are obtained by the orthogonal array method through the processor, using the data of the variables and the features of which levels and features in the levels are determined. In the resulting configurations, the data creating the same feature are combined with the data creating different variables.

In an embodiment of the invention, the test configuration derivation system comprises parameters grouped as factors and variables, considering whether they are critical for flight or not. Factors are more critical parameters than variables.

In an embodiment of the invention, the test configuration derivation system comprises the processor that allows the factor to be selected by the user as the number of virtual links.

In an embodiment of the invention, the test configuration derivation system comprises the processor that allows variables to be selected by the user as the number of ports, bandwidth allocation gap, minimum frame size, maximum frame size and priority.

In an embodiment of the invention, the test configuration derivation system comprises the processor that allows determining the number of the first power, which is predetermined by the user and affects the number of configurations to be tested that the factor data will create among themselves. Instead of using all combinations of factor data with each other, the aim is to obtain the optimum number of configurations by grouping the combinations according to the first power number. When creating a combination group with the orthogonal array method, combinations with a lot of common data are used. A second power number is predetermined by the user and affects the number of configurations that the variables and the feature's data will create among themselves. The processor allows the first power number and the second power number to be different from each other.

In an embodiment of the invention, the test configuration derivation system comprises the processor that allows the user to select the number of the first power to be larger than the number of the second power. Therefore, it is possible to test configurations in which factors determined by the user to be more effective for deriving a test configuration occur more frequently than variables.

In an embodiment of the invention, the test configuration derivation system comprises factors and variables that have the same level. The feature derived from the configurations obtained from the data at the levels of the factors may have different levels than the factors and variables.

In an embodiment of the invention, the test configuration derivation system comprises the processor that allows testing of all configurations with binary combinations between factors. In an embodiment of the invention, the test configuration derivation system comprises the processor that uses Taguchi method for creating orthogonal arrays.

In an embodiment of the invention, according to the test configuration derivation system, for testing the switch in deterministic avionics networks, the number of virtual links passing through each port is determined by the user as a factor. To test the switch, the number of ports, bandwidth allocation gap, minimum frame size, maximum frame size and priority parameters, which depend on the operating performance of the virtual link, are determined as variables. The orthogonal array is applied to the factors, so that configurations containing combinations of data at the levels of the factors are obtained. A feature with as many levels as the number of configurations created is created by combining the configuration data forming that level at each level. The orthogonal array method is applied to the variables and the feature obtained from the factor, so that almost all configurations are tested by the processor.

The test configuration derivation system realized to achieve the object of the invention is illustrated in the attached drawings, in which:

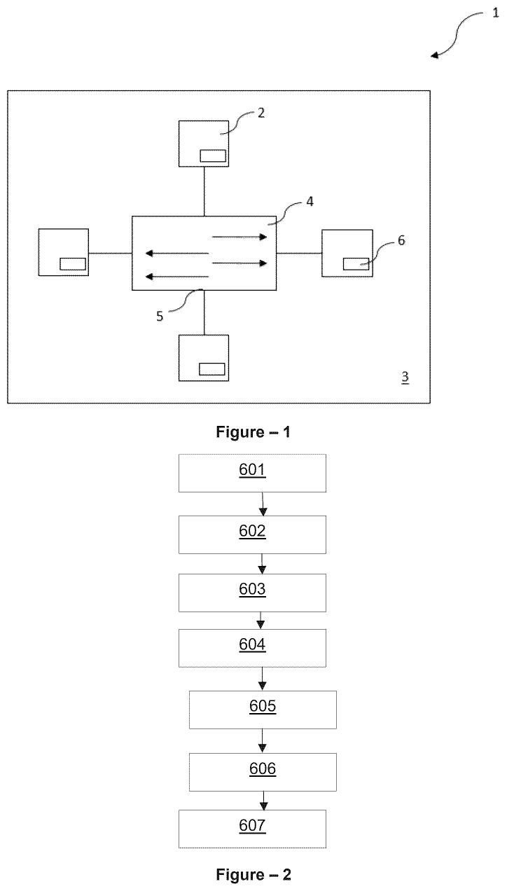

FIG. 1 is a block diagram of the computer network.

FIG. 2 is a flow diagram of the test configuration derivation system.

All the parts illustrated in figures are individually assigned a reference numeral and the corresponding terms of these numbers are listed below:
1. Test configuration derivation system
2. Electronic equipment
3. Computer network
4. Switch
5. Port
6. Processor

It comprises multiple electronic equipment (2) that can communicate with each other; at least one computer network (3) forming Ethernet data network for the electronic equipment (2); at least one switch (4) that manages data communication in the computer network (3); at least one port (5) that provides data input and/or output between the electronic equipment (2); at least one processor (6) that enables performance testing of the computer network (3);
predetermining multiple parameters of the port (5) for testing the computer network (3) by the user (601);
predetermining, by the user, a level of each parameter that indicates the possible values for the parameters, and the data at these levels (602);
creating at least one factor with the parameters pre-selected by the user among multiple parameters (603);
creating at least one variable with the parameters pre-selected by the user, other than the parameters in the factor (604);
obtaining combinations of data at the levels of at least two factors, and creating configurations by performing a matching process in the combinations (605).

The test configuration derivation system (1) according to the invention comprises the processor (6) that performs the steps of:
creating a feature, wherein a level of the feature is the number of configurations created by the combination of data at the levels of two factors, and the data of each level is determined by combining the data of the configuration at each level (606);
creating combinations of the data of the variables and the combined data of the feature and performing a matching process for these combinations to obtain configurations, thereby increasing the number of configurations created with different variables for the same feature (607).

The computer network (3) defines the Ethernet data network for multiple electronic equipment (2) communicating with each other. Data communication in the computer network (3) is provided by the switch (4). Data input and/or output between electronic equipment (2) is provided by the port (5). The performance test of the computer network (3) is carried out by the processor (6). The parameters for the port (5) are determined by the user via the processor (6). The number of different possible values for the parameters is the number of levels, and the data at each level represents a possible value for the parameter. Parameters are grouped by the user as factors and variables. The parameters in the factor group are not included in the variable group. Thus, each parameter is included in only one group. Configurations are obtained by matching, grouping and/or combining combinations of factor data.

After the parameters determined to be important for the testing of the computer network (3) are assigned as factors, configurations are created by matching and/or combining the combinations of data in the factors. Configurations consist of rows one under the other as a table, wherein each column in the configuration represents the data of a factor. The configurations of the factors obtained with the orthogonal array are as many as the number of tests. The number of tests/the number of configurations/the number of rows is determined as the level of the derived feature in the processor (6). By combining the data in the columns of each configuration, data is assigned to the levels of the feature. Combining means obtaining new data by writing the data in all columns side by side. Therefore, the feature whose level and data at the levels are obtained from the factors, is created. Configurations are obtained from combinations by applying the orthogonal array method to the data obtained by combining the data of the feature in the columns of the configuration and the data of the variables. These resulting configurations are derived for testing the computer network (3). Thanks to these configurations, the pressure of different combinations of factors is kept to a minimum, as combinations of different variable data are obtained with the same data of the features obtained by combinations of factors. Parameters can be divided into more than two groups, with at least one factor and at least one variable. In this case, a feature is created whose level and data at the levels are obtained from the configuration data created with the data in the parameters in the first group determined by the user as the most important. Configurations are obtained from the combination of the feature and the second data group, and another feature whose level and data at the levels are obtained from the data of these configurations, is created. Configurations are obtained from the combination of other features and third data group, and the process may continue in this manner.

In an embodiment of the invention, the test configuration derivation system (1) comprises the processor (6) which enables:
creating configurations that contain combinations of factor data, following application of an orthogonal array to at least two factors;
creating a feature with a level value in the number of configurations created with the factor data;
creating data at the feature levels by combining the data in the configuration;
creating configurations by applying orthogonal arrays to the variables and features together, thus increasing the number of configurations created with different variables for the same feature. Features are obtained with the configurations crated after applying the orthogonal array method to the factors. The orthogonal array method is used for elements and variables. In this way, the same feature data created from the data in the factors with the orthogonal array method can be combined with different variables. The steps performed by the processor (6) ensure that the optimum number of configurations to be tested are obtained and that the combinations containing the same factor data are more frequent than the combinations containing the same variables.

In an embodiment of the invention, the test configuration derivation system (1) comprises the processor (6) that allows the creation of factors and variables by pre-classifying the port (5) parameters by the user according to their effect on flight performance. Therefore, the data of the factors that are critical for flight are matched with different variable data in the configurations, enabling more critical configurations to be obtained.

In an embodiment of the invention, the test configuration derivation system (1) comprises the processor (6) that allows the number of virtual links to be assigned as a factor. The number of virtual links is an important parameter that indicates the traffic utilization rate of ports (5), and as a result, the defining characteristics of a switch (4). For testing a deterministic network switch, the number of virtual links is the most critical parameter as it directly affects the determination of traffic flows through the use of port (5).

In an embodiment of the invention, the test configuration derivation system (1) comprises the processor (6) which allows the number of ports (5), bandwidth allocation gap, minimum frame size, maximum frame size and priority parameters to be assigned as variables. Bandwidth allocation gap, minimum frame size and maximum frame size determine the traffic transmission rate of the virtual link. The priority parameter directly affects the latency of the virtual link. The number of ports (5), on the other hand, determines the number of virtual link from a port (5) when all virtual links are considered, which is an important parameter that directly affects the latency in the switch (4). Therefore, these parameters need to be tested simultaneously.

In an embodiment of the invention, the test configuration derivation system (1) comprises at least a first power number, which is a number predetermined by the user for performing a matching process between combinations of factors; at least a second power number, which is a number predetermined by the user for performing a matching process between co-created combinations of variables and the feature; the processor (6) that allows the first power number and the second power number to be different from each other. Thanks to the test configuration derivation system (1) in which multiple and consecutive orthogonal array applications are used, the first power number and the second power number can differ from each other. In this way, the number of configurations can be adjusted flexibly according to time, capacity of the processor (6), and criticality.

In an embodiment of the invention, the test configuration derivation system (1) comprises the processor (6) which enables selection of the first power number to be larger than the second power number by the user, so that combinations containing the same factors are more frequent than the combinations containing the variables. By applying the orthogonal array method to features and variables, the same feature data is matched with different variable data in the combinations obtained. Thus, parameter of the number of virtual links, which is considered important, can be tested more comprehensively, taking into account the effects of different variables. In this way, the effect of different combinations of dominant parameters is kept to a minimum by choosing the first power number of the factors to be greater than the second power number, which are considered important/dominant parameters.

In an embodiment of the invention, the test configuration derivation system (1) comprises the processor (6) that allows creation of an orthogonal array with factors and variables that have the same number of levels, and with features that may have different levels than the variables. With the orthogonal array method used to derive test configuration, parameters at the same level and at different levels can be used. This provides flexibility in choosing the parameter to be tested, and since it is at the same level, there is no need for restrictions.

In an embodiment of the invention, the test configuration derivation system (1) comprises the processor (6) that enables all possibilities to be tested in binary combinations between factors. The first power number for the factors is selected by the user as 2 (pair-wise), so that all binary combinations of the first factors are tested.

In an embodiment of the invention, the test configuration derivation system (1) comprises the processor (6) that enables the creation of orthogonal arrays using the Taguchi method. Taguchi method reduces costs by decreasing the number of tests by means of using orthogonal arrays, and also minimizes the effects of uncontrollable parameters/factors/variables with the best combination of controllable parameters/factors/variables.

In an embodiment of the invention, the test configuration derivation system (1) comprises the processor (6) which enables: determining, by the user, the number of virtual links passing through each port (5) of the switch (4) as a factor in deterministic avionics networks;
determining the parameters required for testing the switch (4) by the user as variables, wherein said parameters, which are the number of ports, bandwidth allocation gap, minimum frame size, maximum frame size and priority, affect the operating performance of the virtual link;
obtaining all combinations of the factors by applying the orthogonal array method to the data at the levels thereof, and obtaining configurations by matching the combinations with each other according to the first power number at a value predetermined by the user;
creating features with as many level values as the number of configurations obtained;
creating data at the levels of the feature by combining the data in each or all configurations between each other;
obtaining all combinations by applying the orthogonal array to the combined data in the feature and the data in the variables, and creating configurations by matching the combinations with each other according to the second power number at a value predetermined by the user, thereby increasing the number of configurations created with different variables for the same feature. Modern avionics applications require high-speed data communications. Accordingly, Ethernet-based deterministic network technologies are used. Testing ARINC 664 switches is a difficult task due to their security-critical nature, availability of numerous configuration options, and high-speed operation using thousands of virtual links. The most important elements of an ARINC 664 DTN are the switch (4), end systems and virtual links. Applications running on different end systems communicate with each other using virtual links directed by the switch (4). First, configurations are created from combinations with different numbers of virtual link factors that can be assigned to each switch (4) port (5) by the orthogonal array method. The feature, which has as many levels as the number of these configurations and of which the data of each level is obtained by combining the configuration data, is created by the processor (6). Then, in order to determine the remaining switch (4) variables, such as created feature data, data at the port number level, data at the bandwidth allocation gap level, data at the minimum frame size level, data at the maximum frame size level, and priority parameter; the feature data and the variable data are used as input to the second stage orthogonal array. Therefore, the optimum number of configurations is obtained, so that configurations containing combinations of the same features with different variables, are obtained.

1. A test configuration derivation system (1) comprising multiple electronic equipment (2) that can communicate with each other; at least one computer network (3) forming Ethernet data network for the electronic equipment (2); at least one switch (4) that manages data communication in the computer network (3); at least one port (5) that provides data input and/or output between the electronic equipment (2); at least one processor (6) that enables performance testing of the computer network (3);
enables predetermining multiple parameters of the port (5) for testing the computer network (3) by the user (601);
enables predetermining, by the user, a level that is created by combining the data for each level of the feature with the data for the configuration that creates, for each parameter that indicates the possible values for the multiple parameters, and the data at these levels (602);
enables creating at least one factor which is passing through each port with the multiple parameters pre-selected by the user among multiple parameters (603);
enables creating at least one variable which is determined by the factors with the multiple parameters pre-selected by the user, other than the multiple parameters in the factor (604);
enables obtaining combinations of data at the levels of at least two factors, and creating configurations by performing a matching process which is the combination of the variables created together with a second power number and the attribute, in the combinations (605), wherein the processor (6) that
enables creating a feature, wherein a level of the feature that is created by combining the data of the configuration that creates that level is the number of configurations created by the combination of data at the levels of two factors, and the data of each level is determined by combining the data of the configuration at each level (606);
enables creating combinations of the data of the variables that are selected from the parameters determined by the factors determined by the user to affect the operating performance and the combined data of the feature and performing a matching process for these combinations to obtain configurations, thereby increasing the number of configurations created with different variables for the same feature (607).

2. A test configuration derivation system (1) according to claim 1, wherein the processor (6) which configured to enables creating configurations that contain combinations of factor data that obtained by matching, grouping and/or combining, following application of an orthogonal array to at least two factors;
enables creating a feature with a level value in the number of configurations created with the factor data;
enables creating data at the feature levels by combining the data in the configuration;
enables creating configurations by applying orthogonal arrays to the variables and features together, thus increasing the number of configurations created with different variables for the same feature.

3. A test configuration derivation system (1) according to claim 1, wherein the processor (6) that configured to allows the creation of factors and variables by pre-classifying the port (5) parameters by the user according to their effect on flight performance.

4. A test configuration derivation system (1) according to claim 1, wherein the processor (6) that configured to allows a number of virtual links to be assigned as a factor.

5. A test configuration derivation system (1) according to claim 1, wherein the processor (6) which configured to allows the number of ports (5), bandwidth allocation gap, minimum frame size, maximum frame size and priority parameters to be assigned as variables.

6. A test configuration derivation system (1) according to claim 1, wherein at least a first power number, which is a number predetermined by the user for performing a matching process between combinations of factors; at least the second power number, which is a number predetermined by the user for performing a matching process between co-created combinations of variables that obtained by the orthogonal array method, and the feature; the processor (6) that configured to allows the first power number and the second power number to be different from each other.

7. A test configuration derivation system (1) according to claim 1, wherein the processor (6) which configured to enables selection of the first power number to be larger than the second power number by the user, so that combinations containing the same factors are more frequent than the combinations containing the variables.

8. A test configuration derivation system (1) according to claim 1, wherein the processor (6) that configured to allows creation of an orthogonal array with factors and variables that have the same number of levels, and with features that may have different levels than the variables.

9. A test configuration derivation system (1) according to claim 1, wherein the processor (6) that configured to enables all possibilities to be tested in binary combinations between factors that are selected by the user as pair-wise.

10. A test configuration derivation system (1) according to claim 1, wherein the processor (6) that configured to enables the creation of orthogonal arrays using the Taguchi method.

11. A test configuration derivation system (1) according to claim 1, wherein the processor (6) which configured to enables: determining, by the user, the number of virtual links passing through each port (5) of the switch (4) as a factor in deterministic avionics networks;
determining the parameters required for testing the switch (4) by the user as variables, wherein said parameters, which are the number of ports, bandwidth allocation gap, minimum frame size, maximum frame size and priority, affect the operating performance of the virtual link;
obtaining all combinations of the factors by applying the orthogonal array method to the data at the levels thereof, and obtaining configurations by matching the combinations with each other according to the first power number at a value predetermined by the user;
creating features with as many level values as the number of configurations obtained;
creating data at the levels of the feature by combining the data in each or all configurations between each other;
obtaining all combinations by applying the orthogonal array to the combined data in the feature and the data in the variables, and creating configurations by matching the combinations with each other according to the second power number at a value predetermined by the user, thereby increasing the number of configurations created with different variables for the same feature.
